(19) United States
(12) Patent Application Publication
(10) Pub. No.: US 2025/0044834 A1
(43) Pub. Date: Feb. 6, 2025

(54) ELECTRONIC DEVICE

(71) Applicant: Apple Inc., Cupertino, CA (US)

(72) Inventors: Grant H. Mulliken, Los Gatos, CA (US); Javier Mendez, San Jose, CA (US); Fletcher R. Rothkopf, Los Altos, CA (US); Nikola Vukovic, San Francisco, CA (US)

(21) Appl. No.: 18/391,623

(22) Filed: Dec. 20, 2023

Related U.S. Application Data
(60) Provisional application No. 63/517,548, filed on Aug. 3, 2023.

(51) Int. Cl. G06F 1/16

(52) U.S. Cl. CPC G06F 1/163

(57) ABSTRACT

A head-mountable device includes a display portion a facial interface, a stiffness profile modifier, a sensor, and a securement assembly. The display portion includes a display. The facial interface has a variable stiffness profile. The stiffness profile modifier is configured to automatically change the facial interface from having a first stiffness profile to having a second stiffness profile in response to sensor data. The sensor is configured to generate the sensor profile data. The securement assembly is connectable to the display portion. The securement assembly includes a removable strap and a retention band that is connectable to the removable strap. The removable strap includes electronics.

### CROSS-REFERENCE TO RELATED APPLICATION(S)

This claims priority to U.S. Provisional Application No. 63/517,548, filed 3 Aug. 2023, and entitled “Electronic Device,” the disclosure of which is hereby incorporated by reference in its entirety.

### FIELD

The described embodiments relate generally to electronic devices. More particularly, the present embodiments relate to adjustable features of wearable electronic devices.

### BACKGROUND

Recent advances in portable computing have enabled head-mountable devices that provide augmented reality and virtual reality (AR/VR) experiences to users. Such head-mountable devices can include various components such as a display, a viewing frame, lenses, a battery, motors, speakers, and other components. These components can operate together to provide an immersive user experience. In particular, head mountable-devices include components that help provide a distraction-free setting by blocking or sealing out the outer environment (e.g., ambient light).

The goal of head-mountable devices is prolonged and comfortable use, even though each user has a unique facial profile and thus different engagement points. Therefore, a head-mountable device capable of dynamically adjusting for comfortable prolonged use is desired.

### SUMMARY

In one example, a head-mountable device includes a display portion, a facial interface, a stiffness profile modifier, a sensor, and a securement assembly. The display portion includes a display. The facial interface is connected to the display portion and includes a variable stiffness profile. The head-mountable device also includes a sensor configured to generate sensor data, and a stiffness profile modifier connected to the sensor and configured to change the facial interface from a first stiffness profile to a second stiffness profile in response to sensor data from the sensor.

In at least one example, the head-mountable device can include a removable strap and a retention band that is connectable to the removable strap. The removable strap can include electronics. In some examples, the facial interface includes a heat reactive foam, the sensor is disposed in the facial interface, and the stiffness profile modifier is a heater. Additionally, in some examples, first stiffness profile has a first configuration of first stiffened areas and first relaxed areas, and the second stiffness profile has a second configuration of second stiffened areas different than the first stiffened areas, and second relaxed areas different than the first relaxed areas.

In at least one example, at least one of the first stiffness profile or the second stiffness profile is based on a user activity.

In at least one example, the stiffness profile modifier utilizes induced-temperature flux to change the facial interface from having the first stiffness profile to having the second stiffness profile.

In at least one example, the stiffness profile modifier can include a pump.

In at least one example, the stiffness profile modifier is further configured to change the facial interface from the second stiffness profile to a third stiffness profile in response to additional sensor data.

In at least one example, the head-mountable device includes a manual control to actuate the stiffness profile modifier.

In at least one example, the sensor is a timer.

In at least one example, the sensor is positioned on or within the facial interface.

In one example, an apparatus includes a display portion, a face-engaging structure, a tensioner, a first sensor, and a second sensor. The display portion includes a display. The face-engaging structure has a first modifiable pressure region, and a second modifiable pressure region. The tensioner can include at least one of a mechanical tensioner or a pneumatic tensioner connected to the first modifiable pressure region and the second modifiable pressure region. The first sensor is configured to generate first sensor data and the second sensor is configured to generate second sensor data. The tensioner is configured to actuate when the first sensor data satisfies a first threshold criteria and the second sensor data satisfies a second threshold criteria.

In at least one example, the tensioner includes at least one of a spring, an actuator, or a magnet.

In at least one example, the tensioner includes at least one of a pulley or a bladder.

In at least one example, the first sensor is a camera, and the second sensor includes at least one of a tissue displacement sensor or an electrical signal sensor.

In at least one example, the first modifiable pressure region corresponds to at least one of a zygoma region, a maxilla region, or a forehead region on a human head, and the second modifiable pressure region corresponds to at least one of a zygoma region, a maxilla region, or a forehead region on a human head different than the first modifiable pressure region.

In one example, a wearable apparatus includes a display portion, a foam pad connected to the display portion, a sensor, and a controller. The display portion includes a display. The foam pad includes a first heater and a second heater. The first heater is configured to heat a first portion of the foam pad. The second heater is configured to heat a second portion of the foam pad that differs from the first portion of the foam pad. The controller is communicatively coupled to the sensor, the first heater, and the second heater.

In at least one example, the foam pad is a heat-reactive foam.

In at least one example, the first heater and the second heater are configured to operate at alternating times.

In at least one example, the first heater and the second heater include a first infrared heater and a second infrared heater, respectively.

In at least one example, the first heater and the second heater include a first pneumatic heat line and a second pneumatic heat line.

In at least one example, the first heater and the second heater are configured to use thermal exhaust from the wearable apparatus.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A illustrates a top view of a head-mountable device being worn on a head 101 of a user, according to one example;

FIG. 1B illustrates a perspective view of the head-mountable device, according to one example;

FIGS. 2A-2B illustrate side and front view profiles, respectively, of an example of the head-mountable device;

FIG. 3 illustrates a facial interface with a variable stiffness profile, according to one example;

FIGS. 4A-4C illustrate a portion of a facial interface having a variable stiffness profile, according to one example;

FIG. 5 illustrates a facial interface of a head-mountable device with a pneumatic tensioner including a pneumatic bladder, according to one example;

FIG. 6 illustrates a facial interface of a head-mountable device with a thermal tensioner including a first heater and a second heater, according to one example;

FIG. 7 illustrates a facial interface of a head-mountable device with a pneumatic heat tensioner, according to one example;

FIG. 8 illustrates a facial interface of a head-mountable device with a mechanical tensioner, according to one example; and

FIG. 9 shows a high-level block diagram of an electronic device that can be used to implement examples of the present disclosure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to a head-mountable device which can include a display portion including a display, a facial interface, a stiffness profile modifier, a sensor, and a securement assembly. The facial interface can have a variable stiffness profile and the stiffness profile modifier can automatically change the facial interface from having a first stiffness profile to having a second stiffness profile in response to sensor data generated by the sensor. The securement assembly can be connectable to the display portion and can include a removable strap with electronics and a retention band connectable to the removable strap.

By automatically articulating the head-mountable device (HMD) via the stiffness profile modifier, one or more examples of the HMD disclosed herein can increase the comfort experienced by the user. For example, over a prolonged duration of use of a head-mountable device, comfort profiles can change. In a first manner, indications can manifest themselves on the user's face signaling extended use, such indicators can include visually apparent color change where the head-mountable device contacts the user's face. In some instances, facial muscles and tissue experiencing prolonged contact can affect a user's comfort level.

To help increase comfort during extended use, an HMD of the present disclosure can implement a variety of example embodiments. Some examples of an HMD include a stiffness profile modifier to automatically adjust a stiffness of regions or points of contact between the HMD and the user's face. In one example, a stiffness profile modifier can include a pneumatic bladder which can be locally inflated and/or deflated to control a pressure and stiffness of a specific pressure region. In another example, a stiffness profile modifier can include various heaters or heat sources which can transport thermal energy along thermally conductive channels to selectively and controllably soften or harden seat-sensitive foam. Heaters can be infrared heaters, radiative heaters, or can utilize native heat dissipation from the HMD. In another example, a stiffness profile modifier can include a pneumatic heat tensioner which can transport temperature-controlled gas or liquid to modify stiffness/pressure of pressure regions. In another example, a stiffness profile modifier can include a mechanical tensioner which selectively tightens/loosens lines to adjust the pressure regions. Other examples can include utilizing a magnetic-field-based viscosity dependence of a fluid, mechanical springs, etc. Additionally or alternatively, these or other examples can be combined in a variety of ways, as may be desired. Additionally or alternatively, various examples of an HMD can implement a stiffness profile modifier that can be adjusted manually (e.g., via an input control, such as a button or dial) or via hands-free communication (e.g., hand gestures, eye movements, voice-commands, etc. detected by a sensor disclosed herein).

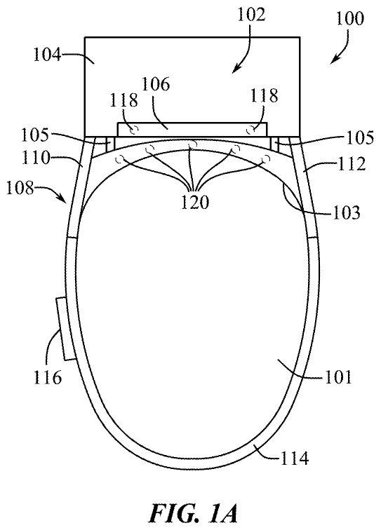

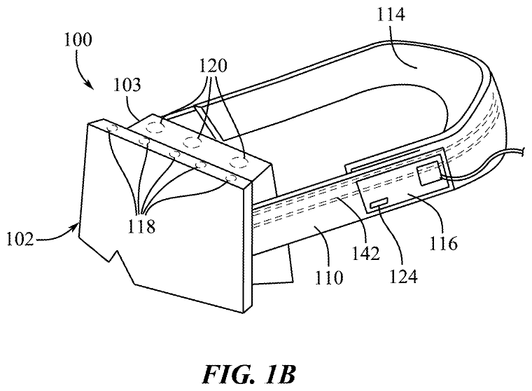

These and other examples are discussed below with reference to FIGS. 1-9. However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1A illustrates a top view of a head-mountable device 100 being worn on a head 101 of a user, according to one example. The head-mountable device 100, as well as other wearable electronic devices disclosed herein, can also be referred to as HMD systems, electronic devices, wearable devices or apparatuses, or simply as devices. The head-mountable device 100 can include a number of components, including modular components, interchangeable components, etc. For example, the head-mountable device 100 can include a head-mounted display (HMD) 102, which includes a housing 104 and a display 106 attached to the housing 104 for displaying images to the user.

The HMD 102 can also be referred to as a display portion or display module having the display 106. The display portion can include the housing 104 and the display 106 that at least partially constitutes the HMD. In one or more examples, including the example shown in FIG. 1 and other examples shown in other figures, the HMD 102 can also be referred to as an output component or output module. Such output components, modules, or portions can include one or more outputs other than visual outputs from a display. For example, an output module similar to the HMD 102 can include a speaker that outputs sound instead of, or in addition to, the display 106 shown in FIG. 1. As another example, HMD 102 (as an output module) can include a haptic interface for generating vibrations or other sensory outputs.

The head-mountable device can 100 also include a facial interface 103. As used herein, the terms “facial interface” or “interface” refer to a portion of the head-mountable device 100 that engages a user face via direct contact. In particular, a facial interface includes portions of the head-mountable device 100 that conform to (e.g., compress against) regions of the user face. For example, a facial interface may include a pliant (or semi-pliant) face track or foam that spans the forehead, wraps around the eyes, contacts the zygoma and maxilla regions of the face, and bridges the nose. Furthermore, a facial interface can include various components forming a structure, webbing, cover, fabric, or frame of a head-mountable device disposed between the HMD 102 and the skin of a user. In particular implementations, a facial interface can include a seal (e.g., a light seal, an environment seal, a dust seal, an air seal, etc.). It will be appreciated that the term “seal” can include partial seals or inhibitors, in addition to complete seals (e.g., a partial light seal where some ambient light is blocked and a complete light seal where all ambient light is blocked when the head-mountable device is donned).

The facial interface can include a variable stiffness profile which can have different configurations of stiffened areas and relaxed areas. As used herein, a stiffened area is an area of the facial interface that is actuated by the stiffness profile modifier (e.g., tensioner) to increase pressure on the user's face compared to a non-actuated area of the facial interface. Further, a relaxed area is an area of the facial interface that is not actuated by the stiffness profile modifier. In some examples, different areas of the facial interface can be actuated (e.g., a stiffened area) to varying degrees. For example, a first area of the facial interface can be a first stiffened area with a first stiffness greater than a stiffness of the relaxed area, and a second area of the facial interface can be a second stiffness area with a second stiffness that is different from the first stiffness and is greater than the stiffness of the relaxed area. For example, the facial interface can have a first stiffness profile including a configuration of stiffened areas and relaxed areas; and the facial interface can have a second stiffness profile including a configuration of stiffened areas and relaxed areas that are at least partially different from the first configuration of stiffened areas as and relaxed areas. Furthermore, the facial interface can have additional stiffness profiles, such as third, fourth, fifth, etc. that include configurations that are at least partially different from each of the other configurations of stiffened areas. The head-mountable device 100 can include a stiffness profile modifier to change the stiffness profile of the facial interface.

In addition, the exemplary head-mountable device 100 can include connector(s) 105. As used herein, the terms “connector” or “joint” refer to a joining between the HMD 102 and the facial interface 103. In some examples, a connector allows the facial interface 103 to translate or rotate relative to the HMD 102 via the connector. In other examples, a connector allows the facial interface 103 to both translate and/or rotate relative to the HMD 102. In at least some examples, the facial interface 103 can be removably attached to, and detached from, the connector(s) 105 (or another portion of the HMD 102). For instance, in certain examples, the facial interface 103 can be swapped out for a different facial interface. In other examples, the facial interface 103 is permanently attached to the connector(s) 105. In particular implementations, the connector(s) 105 moveably constrain the facial interface 103 to the HMD 102 at one or more various positions, such as a forehead region, a zygoma region, or a maxilla region.

As used herein, the term “forehead region” refers to an area of a human face between the eyes and the scalp of a human. Additionally, the term “maxilla region” refers to an area of a human face corresponding to the zygomatic bone structure of a human. Similarly, the term “maxilla region” refers to an area of a human face corresponding to the maxilla bone structure of a human. It will be appreciated that the foregoing regions can correspond to particular structure of the head-mountable device 100. However, such structure of the head-mountable device 100 is not dependent on a face or a user.

The head-mountable device 100 can include one or more sensors 118 and 120 disposed on or within at least one of the facial interface 103 or the display portion. As depicted in FIG. 1A, the sensor(s) 118 can be disposed on or within the display 106, and the sensor(s) 120 can be disposed on or within the facial interface 103. The sensor(s) 118 and 120 can be configured to generate sensor data. The sensor(s) 118 and 120 can generate various sensor data. Any of the sensor(s) 118 and 120 can include one or more of a timer, a camera, a pressure sensor, a temperature sensor, a tissue displacement sensor, and electrical signal sensor, a vibration sensor, or any combination thereof. Additionally or alternatively, the sensor(s) 118, 120 can include an oxygen device, a movement device, a brain activity device, a sweat gland activity device, a breathing activity device, a muscle contraction device, a nerve signal detection device, etc. Some particular examples of sensors can include an electrooculography sensor, an electrocardiography sensor, an EKG sensor, a heart rate variability sensor, a blood volume pulse sensor, an SpO2 sensor, a compact pressure sensor, an electromyography sensor, a core-body temperature sensor, a galvanic skin sensor, an accelerometer, a gyroscope, a magnetometer, an inclinometer, a barometer, an infrared sensor, a global positioning system sensor, etc. The head-mountable device 100 can include a stiffness profile modifier (not shown) which is configured to automatically change the facial interface 103 between the various stiffness profiles (e.g., from the first stiffness profile to the second stiffness profile) in response to sensor data generated by the sensor(s) 118 and 120.

In addition, one example of the device 100 can include a securement assembly 108 that secures the HMD 102 to the user's head 101. The securement assembly 108 can include removable straps 110, 112. As used herein, the term “removable strap” refers to an element (e.g., a band, connection piece, etc.) that couples the HMD 102 and the retention band 114. In particular examples, the removable straps 110, 112 removably (i.e., detachably) connect to both of the HMD 102 and the retention band 114. For example, each of the removable straps 110, 112 can be removably connected to the HMD 102 (or the housing or the display portion thereof) and the retention band 114 at opposing ends of each removable strap 110, 112, as shown in FIG. 1. In such an example, the securement assembly 108 is modular in that each of the removable straps 110, 112, and the retention band 114 can be connected and detached, as may be desired. For instance, each of the removable straps 110, 112 can be removed from the securement assembly 108 and swapped out for one or more other modules, straps, or electronic components.

In these or other examples, at least one of the removable straps 110, 112 can include electronics, such as connectors or ports for data and/or power transmission (e.g., via dongles or tethers). For instance, the removable straps 110, 112 can couple to an external device or display. In another instance, the removable straps 110, 112 can couple to a power supply.

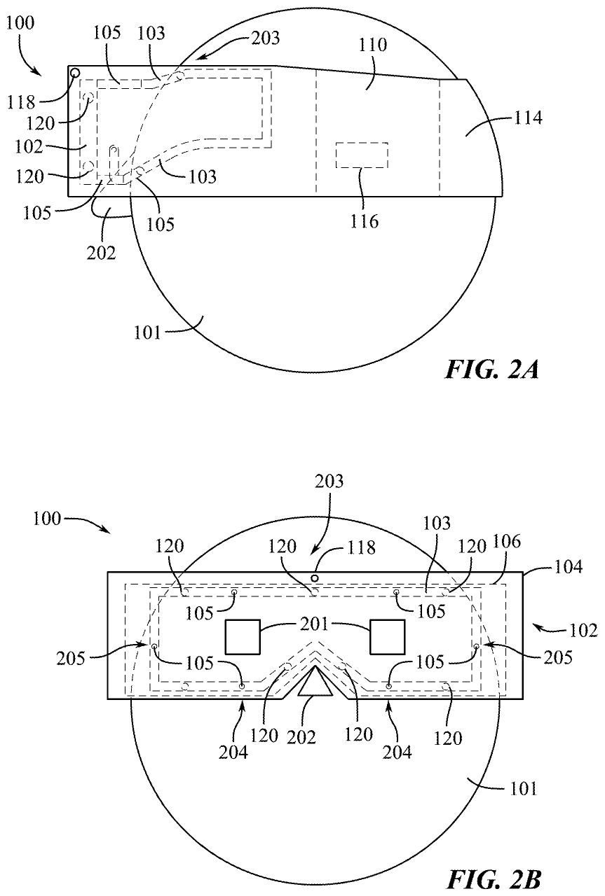

In certain examples, the removable straps 110, 112 include an electronics pod 116 (shown in FIG. 2A). As used herein, the term “electronics pod” refers to a subassembly, an enclosure, or a shell dedicated for housing certain electronics. Some example electronics include a speaker, memory device, processor, controller, system on chip, printed circuit board, etc. In particular implementations, electrical components of the electronics pod are communicatively coupled to the HMD 102 (e.g., via one or more cables). Additionally or alternatively, the electronics pod can be coupled to one or more dongles, adapters, connectors, etc. In some examples, the head-mountable device 100 can include an input device such as a button 124. The button 124 can function as a manual control to actuate the stiffness profile modifier. In some examples, the head-mountable device 100 can additionally or alternatively include one more manual controls such as toggles, levers, dials, buttons, sliders, rockers, switches, etc. to allow a user to manually actuate the stiffness profile modifier. The button 124 (as well as other manual controls) can allow the user to manually actuate the stiffness profile modifier, rather than waiting for it to be done automatically (e.g., based on sensor data), if desired.

The securement assembly 108 can further include a retention band 114 connectable to the removable strap. As used herein, the term “retention band” refers to a securing element that helps positionally secure the device 100 in place. A retention band can include a band, a tie, or another securement element (e.g., to secure the device 100 on or around the user's head 101). Additionally, a retention band can be formed of a variety of materials, such as knit fabric, silicone, foam, etc. In some examples, a retention band can be loosened or tightened for comfort and proper fit. The securement assembly 108 is therefore configured to removably secure the head-mountable device 100, including the HMD 102, to the head 101 of the user when the removable straps 110, 112 and retention band 114 are connected, as shown in FIG. 1.

One or more other examples of the device 100 can include alternative configurations of the removable straps 110, 112 shown in FIG. 1. For example, the device 100 can be positioned elsewhere along the securement assembly 108 (differently than shown in FIG. 1). In addition, one or more examples of wearable electronic devices described herein can include one or more intermediate members, flexible straps, or other optional supplemental components and electronic modules, such as external power supplies, memory components, and/or processors.

In the example shown in FIG. 1, when the device 100 is worn on the head 101 of the user, the removable strap 110 is positioned on the left side of the user's head and the removable strap 112 is positioned on the right side of the user's head. The retention band 114 can span between the removable straps 110, 112 to wrap around the back of the user's head 101 and secure the device 100 on the user's head 101, as shown.

In some examples, and as shown, the device 100 can be worn on the user's head 101 such that the HMD 102 is worn on the user's face and disposed over one or both of the user's eyes. The HMD 102 can be removably connected to one or more of the removable straps 110, 112 as mentioned above. In some examples, the removable straps 110, 112 can be positioned against the side of a user's head 101, and can be in contact therewith. In some examples, the removable straps 110, 112 can be positioned above the user's ear or ears. In some examples, the removable straps 110, 112 can be positioned adjacent to the user's ear or ears. The removable straps 110, 112 can be removably connected to the retention band 114, which can extend around the user's head 101 and can removably connect to the other of the removable straps 110, 112. In this way, the HMD 102, removable straps 110, 112, and retention band 114 can form a loop that can securely retain the device 100 on the user's head 101. While a single loop configuration is illustrated in FIG. 1, any number of loop and/or strap configurations can be incorporated with, and can form a part of, the exemplary device 100.

As mentioned, the removable straps 110, 112 can connect to the HMD 102, both mechanically and electrically. In particular examples, the removable straps 110, 112 can receive and/or relay at least one of data or power via such connections. In these or other examples, the removable straps 110, 112 can connect to the HMD 102 at an HMD connection location that can include an electrical input or electrical connector that is attached to the housing 104 and electrically connected to the display 106. This location can be identified as a temple area that can be defined as an area near a user's temple adjacent to the user's eye and can span from in front of the user's eye to approximately 1.0-1.5 inches past the outer corner of a user's eye, along the side of the user's head 101.

Similarly, the removable straps 110, 112 can connect to the retention band 114 at a retention band connection location identified as an area that can span to include the area above the user's ear or within 0.5 inches of the outer edge of the ear on either side. In this manner, the removable straps 110, 112 are able to provide structural support between the HMD 102 and the user's ear, while securely connecting the retention band 114 and transferring the retention forces of the retention band 114 through the device 100. It should be understood, however, that this configuration is just one example of how the components of the head-mountable device 100 can be arranged, and that in some examples, a different number of removable straps and/or retention bands can be included.

While a user wearing an HMD 102 on his or her head 101 is shown as one example of a wearable electronic device, the modular components, features, and advantages of various examples of electronic devices disclosed herein can also apply to other wearable electronic devices having securement mechanisms, including but not limited to wearable smart watches, fitness trackers, smart glasses, medical monitor devices, and so forth. For example, the housing 104 and display 106 of HMD 102 shown in FIG. 1 can also be configured as a housing and display for a smart watch module secured to the user's arm or wrist via a securement mechanism or assembly similar to the securement assembly 108 shown in FIG. 1. Although referred to as a head-mountable device 100, it should be understood that the device 100 can include multiple modular components or devices and can be interchangeably referred to as a wearable electronic device, wearable apparatus, wearable electronic device system, and/or wearable electronic system. Additionally, although a particular component can be referred to as an HMD, it should be understood that the terms HMD, HMD device, and/or HMD system can be used to refer to the electronic device 100 as a whole.

FIG. 1B illustrates a perspective view of the head-mountable device 100, according to one example. As shown, the device 100 includes at least some of the same or similar features discussed above in relation to FIG. 1A, such as the HMD 102, the removable straps (e.g., the removable strap 110), the electronics pod 116, the retention band 114, and so forth.

In addition, the device 100 can include an adjustable tension mechanism 142. As used herein, the term “adjustable tension mechanism” refers to one or more elements that can change the tension of at least one component retaining the HMD 102 against a user's head. In certain examples, an adjustable tension mechanism includes one or more tension wires, cables, or similar tensioning elements. In some examples, the adjustable tension mechanism includes one or more clips, belts, straps, etc. to allow the user of the head-mountable device 100 to adjust the strap about the user's head.

Any of the features, components, parts, including the arrangements and configurations thereof shown in FIGS. 1A-1B can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIGS. 1A-1B. Additional details of the device, including detailed profile views are detailed below with reference to FIGS. 2A-2B.

FIGS. 2A-2B illustrate side and front view profiles, respectively, of an example of the head-mountable device 100. As discussed above, the head-mountable device 100 includes the HMD 102 (which includes the housing 104 and the display 106), the facial interface 103, and the connector(s) 105. In particular, as shown in FIGS. 2A-2B, the facial interface 103 can have a variety of contact points with a human face (or in alternative examples, other body portions such as a wrist). Moreover, as will be discussed below, the facial interface 103 can dynamically change contact points, pressure points, and/or stiffness profiles along a human face, head or body (e.g., in real-time responsive to sensor data indicative of a detected prolonged tissue engagement, detected temperature, detected blood flow, user input, a lapse of a predetermined amount of time, etc.).

As used herein, the term “contact point” refers to a particular tissue area and/or bony structure engaged (e.g., touched or compressed against) by the facial interface 103. For instance, the facial interface 103 comprises contact points that include areas around the eyes 201, over the nose region 202, span the forehead region 203, and touch a maxilla region 204 and a zygoma region 205. The foregoing examples of contact points correspond to global facial areas and facial anatomy. However, contact points can also refer to more granular positioning and localized touchpoints. For instance, a contact point can refer to a first tissue portion on one side of a blood vessel, and another contact point can refer to a second tissue portion on the other side of the blood vessel. In another instance, a contact point can reference one or more skin pores, and another contact point can reference another one or more skin pores.

In at least one example, the facial interface 103 (also referred to as a face-engaging structure) includes modifiable pressure regions which correspond to at least one of the nose region 202, the zygoma region 205, the maxilla region 204, or the forehead region 203 on the human head 101. The head-mountable device can include a tensioner, as describe below with respect to the remaining figures. The tensioner can include at least one of a mechanical tensioner, an electromechanical tensioner, a thermal tensioner, or any other tensioner to actuate the modifiable pressure regions. The tensioner can be configured to actuate when sensor data generated by sensor(s) 118 and 120 satisfy respective threshold criteria. In some examples, the sensors 118 and 120 can include thermometers and the tensioner can modify the pressure regions when the contact point exceeds a certain threshold temperature indicating prolonged use by the user. In some examples, the sensors 118 and 120 can include cameras and the tensioner can modify the pressure region upon detection of muscle movement and/or eye movement that exceeds a threshold frequency or amplitude, which can be indicative of user comfort. In some examples, the sensors 118 and 120 can include various mechanical and electrical sensors which can receive nerve signals, muscle signals, galvanic skin sensor measurements, etc. which can be used to measure user comfort.

Additionally shown in FIG. 2B are some example locations of the connector(s) 105. In particular examples, the connector(s) 105 are located at the forehead region 203, the maxilla region 204, and the zygoma region 205. Other locations of the connector(s) 105 are herein contemplated. However, the connector(s) 105 in at least some or all of these exemplary positions can provide a dynamic, yet stable connection between the HMD 102 and the facial interface 103. In alternative implementations, one or more of the connector(s) 105 can be omitted. For instance, the facial interface 103 can include dynamic loading capabilities that allow for intentional (and varied) pressure loading against the human face without the need for fixed connectors or posts at one or more specific facial regions. In certain implementations, modifying the pressure regions of the facial interface 103 can provide such a dynamic response with the human face.

It will be appreciated that the connector(s) 105 at the different locations can be the same, or in certain cases, different. For instance, the connector(s) 105 can include a first joint (e.g., socket joint, soft joint, molded hinge joint, butterfly flexure joint, cam pivot joint, cross axis pivot joint, etc.) positioned at the forehead region 203. In addition, the connector(s) 105 can include a second joint, different from the first joint, such as a pivot joint, elastomer spring joint, soft joint, single ball joint, etc. Indeed, different arrangements and types of the connector(s) 105 can be implemented to provide a particular force profile, amount of rigidity, stiffness, pressure, etc.

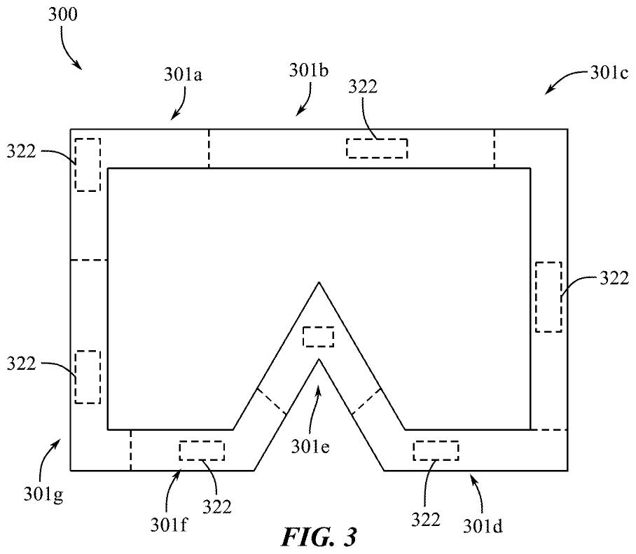

Any of the features, components, and/or parts, including the arrangements and configurations thereof shown in FIGS. 2A-2B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 2A-2B. Additional details of the device, including a profile view showing example pressure regions along the facial interface are detailed below with reference to FIG. 3.

FIG. 3 illustrates a facial interface 300 with a variable stiffness profile, according to one example. The facial interface 300 can have various stiffness profiles such that different regions 301 of the facial interface 300 can have a different stiffness. As will be described in more detail below, in at least one example, the facial interface 300 can include a foam pad or other type of material to contact the face of the user. A stiffness profile modifier 322 can be configured to automatically change the facial interface from having a first stiffness profile to having a second stiffness profile, for example in response to sensor data. As used herein, the terms “stiffness profile modifier” or “tensioner” refer to one or more components that function separately or in combination to adjust the stiffness of one or more pressure regions of the facial interface. In particular, a stiffness profile modifier or a tensioner includes an actuator to generate a force to modify the one or more pressure regions of the facial interface. The stiffness profile modifier or the tensioner can also include accessory components that transfer the force from the actuator to the various pressure regions. Examples of a stiffness profile modifier or tensioner can include a pneumatic tensioner, a thermal tensioner, a mechanical tensioner, etc. In some examples, a stiffness profile modifier or tensioner can include electronic components. For example, a memory of the stiffness profile modifier can include computer executable instructions that, when executed by a processor of the stiffness profile modifier, cause certain components to actuate, turn off, regulate/modify stiffness, etc. as described in further detail below.

In at least one example, a stiffness profile can be characterized by different stiffness, firmness, or other properties along the facial interface 300. A first region 301a of the facial interface 300 can have a first stiffness, a second region 302b can have a second stiffness, a third region 302c can have a third stiffness, a fourth region 302d can have a fourth stiffness, a fifth region 301e can have a fifth stiffness, a sixth region 301f can have a sixth stiffness, a seventh region 301g can have a seventh stiffness, and so forth.

Although depicted in FIG. 3 as having seven stiffness regions 301a-g, the head-mountable device can have any suitable number of stiffness regions whose stiffness or firmness can be varied and adjusted independently by the stiffness profile modifier 322. In some examples, the stiffness of each of the stiffness regions can be adjusted by modifying the corresponding pressure that is exerted on the user's face. As such, a stiffness region can also be referred to as a modifiable pressure region.

In one example, a head-mountable device can include a first stiffness region corresponding to a portion of the facial interface 300 contacting a left side of the user's face, and a second stiffness region corresponding to a portion of the facial interface 300 contacting a right side of the user's face. Alternatively, a head-mountable device can have a first stiffness region corresponding to the zygoma region 205 on the user's head, a second stiffness region corresponding to the maxilla region 204 on the user's head, and a third stiffness region corresponding the forehead region 203 of the user's head.

In at least one example, the stiffness profile modifier 322 includes a heater. The stiffness profile modifier 322 can utilize induced-temperature flux to change the facial interface 300 from having the first stiffness profile to having the second stiffness profile. As defined herein, induced-temperature flux can refer to heat or thermal energy that is directed along the facial interface 300 in order to adjust rigidity, stiffness, or other properties of various regions. In other terms, induced-temperature flux can refer to a directed flow of thermal energy. The stiffness profile modifier 322 can be actuated in response to sensor data.

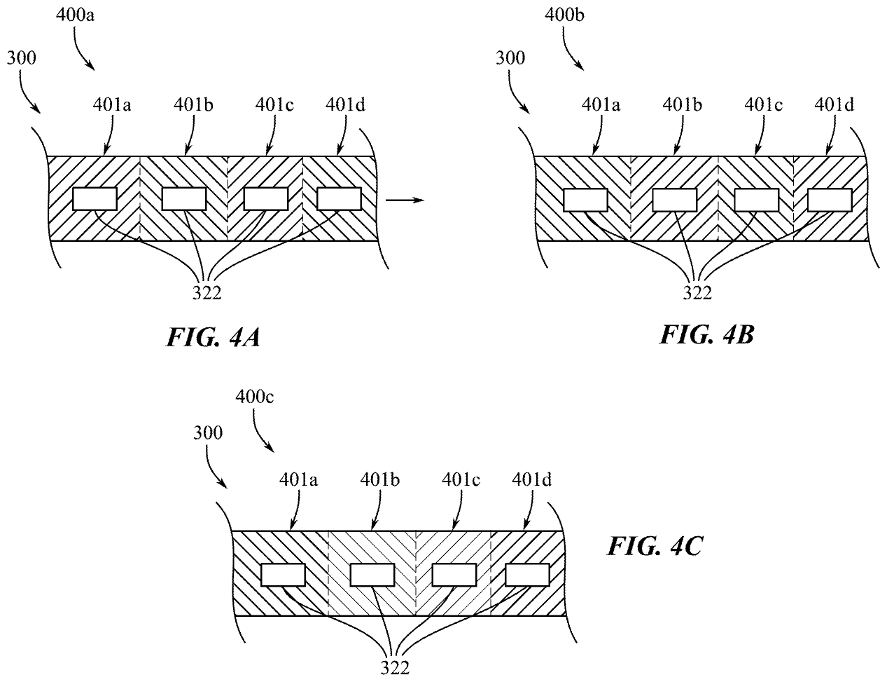

Any of the features, components, parts, including the arrangements and configurations thereof shown in FIG. 3 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 3. Additional details of the facial interface 300 and the stiffness profiles are detailed below with reference to FIG. 4.

FIGS. 4A-4C illustrate a portion of a facial interface 300 having a variable stiffness profile, according to one example. The facial interface 300 can include the stiffness profile modifier 322 configured to automatically change the facial interface 300 from having a first stiffness profile 400a to having a second stiffness profile 400b. In some examples, the stiffness profile modifier 322 is further configured to change the facial interface from having the second stiffness profile 400b to having a third stiffness profile 400c. More specifically, the facial interface 300 can have modifiable pressure regions (e.g., stiffness regions), including pressure regions 401a-d, which are areas with adjustable stiffness levels. A stiffness level (or stiffness) can represent an amount of force applied to achieve an amount of deformation or displacement (represented as stiffness=force/deformation). Thus, higher stiffness levels can demand greater applied loads to achieve deformation, and lower stiffness levels can demand smaller applied loads to achieve deformation. In other terms, higher stiffness levels allow less displacement for a given force compared to lower stiffness levels.

The stiffness profile can be characterized by a particular distribution of varying stiffness or rigidity (e.g., regions of stiffened or firmed areas and relaxed areas) along the facial interface 300. In these or other examples, the stiffness profile modifiers 322 can cooperate or work in tandem to actuate at specific times (e.g., alternating times, scheduled times, learned times, or manually initiated times). In some examples, the stiffness profile modifiers 322 can work in pairs or groups such that multiple stiffness profile modifiers 322 are actuated at a given time, while simultaneously another pair or group of stiffness profile modifiers 322 are unactuated (e.g., powered off or in sleep mode). Additionally or alternatively, one or more stiffness profile modifiers 322 can actuate at differing levels of power (e.g., such that corresponding regions surrounding a stiffness profile modifier is heated/cooled less or more, depending on the amount of power expended by or allotted to the stiffness profile modifier).

As shown in FIGS. 4A-4C, the stiffness profile modifiers 322 generate respective pressure regions with variable levels of stiffness. For example, as depicted in FIGS. 4A-4C, the first stiffness profile 400a is characterized by the first pressure region 401a having a first stiffness level, the second pressure region 401b having a second stiffness level, the third pressure region 401c having the first stiffness level, and the fourth pressure region 401d having the second stiffness level (indicated by the differing fill pattern). The second stiffness profile 400b is characterized by the first pressure region 401a having the second stiffness level, the second pressure region 401b having the first stiffness level, the third pressure region 401c having the second stiffness level, and the fourth pressure region 401d having the first stiffness level. The third stiffness profile 400c is characterized by the first pressure region 401a having the second stiffness level, the second pressure region 401b having the second stiffness level, the third pressure region 401c having the first stiffness level, and the fourth pressure region 401d having the first stiffness level.

In one example, the first stiffness profile 400a can correspond to an example distribution of varying levels of firmness or stiffness in which the zygoma region is stiffer than the maxilla region, which is stiffer than the forehead region, while the second stiffness profile 400b can correspond to a distribution of varying levels of firmness or stiffness in which the maxilla region and/or the forehead region is stiffer than the zygoma region. Additionally or alternatively, any of the zygoma, maxilla, or forehead regions can be split into separate pressure regions, which can each have a defined stiffness.

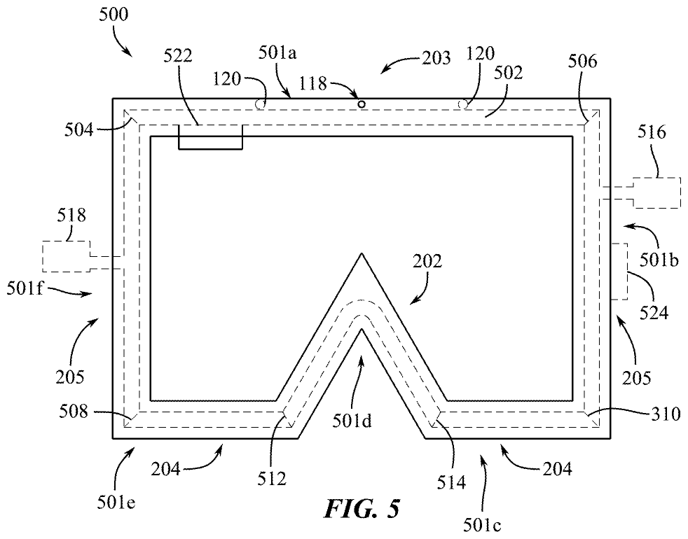

It will be appreciated that the facial interface 300 can have additional pressure regions not depicted in FIGS. 4A-4C. Alternatively, the facial interface 300 can have fewer pressure regions than are depicted in FIGS. 4A-4C. In at least one example, one or more of the modifiable pressure regions 401a-d correspond to at least one of a zygoma region, a maxilla region, or a forehead region on a human head. As will be further detailed with respect to at least FIGS. 5-8, the stiffness profile modifier 322 can include one or more mechanisms that allow for adjustment of stiffness and/or pressure of each pressure region, including pressure regions 401a-d.

It will be appreciated that the stiffness, firmness, or rigidity of the pressure regions are not limited to a first stiffness and a second stiffness. Rather, the stiffness profile modifier 322 can be actuated to cause the pressure regions to have any appropriate stiffness based on sensor data, manual input, or the like.

Any of the features, components, and/or parts, including the arrangements and configurations thereof shown in FIGS. 4A-4C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 4A-4C. Additional details of an exemplary devices with different types of stiffness profile modifiers are detailed below with reference to FIGS. 5-8. In particular, details of an exemplary device including a pneumatic tensioner are detailed below with reference to FIG. 5.

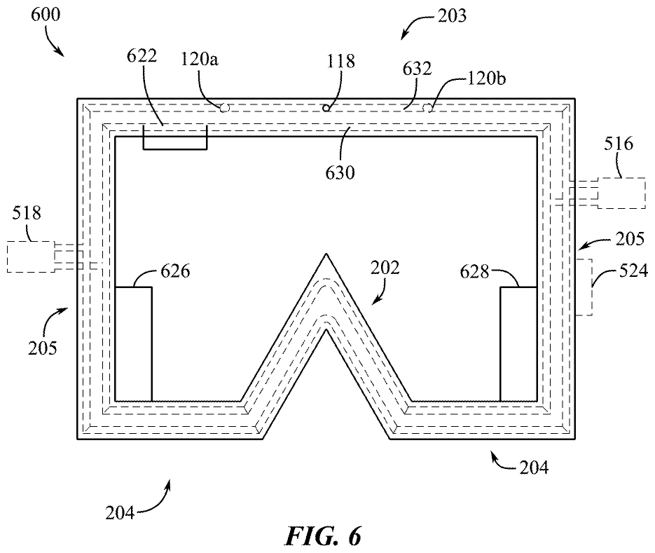

FIG. 5 illustrates a facial interface 500 of a head-mountable device with a pneumatic tensioner 522 including a pneumatic bladder 526, according to one example. The facial interface 500 is substantially similar to the facial interfaces 600-800 of FIGS. 6-8, except that the facial interface 600 can include a different type of tensioner. The pneumatic tensioner 522 is an example of a stiffness profile modifier discussed above. In particular, the pneumatic tensioner 522 can adjust a stiffness of one or more regions of the pneumatic bladder 502 by adjusting one or more of a tension or a pressure within the pneumatic bladder 502 via addition, removal, distribution, or movement of a gas or fluid within the pneumatic bladder 502. Although the features of the facial interface 500 and the pneumatic bladder 502 are described in the context of a gas, the same or similar principles are applicable to a fluid or liquid within the pneumatic bladder 502.

As shown, the facial interface 500 includes the pneumatic bladder 502. A pneumatic bladder can refer to a bag or closed tube which can be inflated and deflated with a gas or a fluid to set a desired pressure within the bag. In the depicted example, the pneumatic bladder 502 can include five modifiable pressure regions 501a-f which can each be inflated to a given pressure. In general, the pneumatic bladder 502 can have one or more modifiable pressure regions (e.g., 1, 2, 3, 4, 6, 10, etc.) which can each be inflated to a given pressure. Alternatively, the pneumatic bladder 502 can be a closed loop (e.g., having only a single pressure region, such that the pressure is uniform along the entire pneumatic bladder). In some examples, the pneumatic bladder 502 can take on various forms and configurations, such as a bladder, elastic (e.g., expandable and compressible) veins, passageways, inflatable portions, etc. In some examples, the pneumatic bladder 502 can be resilient to deformation, force, pressure, or manipulation.

In at least one example, the pressure regions 501a-f can be in fluid communication with one or more other pressure regions (e.g., the pressure region 501a can be in fluid communication with the pressure regions 501b and 501f; the pressure region 501b can be in fluid communication with the pressure regions 501a and 501c; the pressure region 501c can be in fluid communication with the pressure regions 501b and 501d; the pressure region 501d can be in fluid communication with the pressure regions 501c and 501e; and the pressure region 501e can be in fluid communication with the pressure regions 501d and 501a). The pneumatic bladder 502 can include control values 504-514 to allow for fluid communication.

The term “fluid communication” refers to the ability for gas (or liquid) to flow between components or mechanisms. Components or mechanisms in fluid communication can thus send and/or receive gas or liquid from other components. It will be appreciated, however, that components or mechanisms in fluid communication need not require active operations (e.g., the receipt, storage, or transmission of fluid). For instance, fluid can passively pass through components or mechanisms that are in fluid communication with each other.

Each of the control valves 504-514 separate adjacent pressure regions 501a-e and are configured to maintain gas within a given pressure region and/or to allow gas to flow from one pressure region to an adjacent pressure region to adjust the corresponding stiffness. The control valves 504-514 can allow for unidirectional gas flow or bi-directional gas flow. The control valves 504-514 can include relief valves, reducing valves, sequencing valves, counterbalance valves, safety valves, unloading valves, or the like. In particular examples, a control valve can also regulate (or manipulate) pressure and/or flow rate. In these or other examples, a control valve can be actuated (e.g., opened, closed, and/or moved to a partially opened/closed position) electrically, pneumatically, or hydraulically.

In one example control values 504-516 can be implemented to control gas into or out of a portion of the pressure region 501a corresponding to the forehead region 203. Additionally or alternatively, the control valves 504 and 508 (as well as 506 and 510) can be implemented to control gas into or out of a portion of the pressure regions 501b and 501f corresponding to the zygoma region 205. Additionally or alternatively, the control valves 510 and 514 (as well as 508 and 512) can be implemented to control gas into or out of a portion of the pressure regions 501c and 501e, respectively, corresponding to the maxilla region 204. In this manner, one or more of the control valves 504-514 can cause the pneumatic bladder 502 to inflate or expand in certain portions, while remaining less inflated or less expanded in other portions. In so doing, the pneumatic bladder 502 can vary pressure exerted by the facial interface 500 on a human face.

In these or other examples, the pneumatic bladder 502 can include a closed-loop system or an open-loop system. In the closed-loop system, the pneumatic bladder 502 can include a predetermined volume of gas that is fixed within the pneumatic bladder 502. That is, in the closed-loop system, the pneumatic bladder 502 permanently maintains an amount of gas or liquid that does not exit the pneumatic bladder 502. In the open-loop system, the pneumatic bladder 502 can bring in gas and dispel gas. For instance, the pneumatic bladder 502 can pull in ambient air from the environment and exhaust air that has circulated at least a portion of the pneumatic bladder 502.

In at least one example of an open-loop pneumatic bladder 502, the head-mountable device can include a fan 516 and an exhaust 518 in fluid communication with the pneumatic bladder 502. As used herein, the term “fan” refers to an element that can push or move a gas; the term “exhaust” refers to an element that can dispel gas. For example, the fan 516 can bring gas (or air) into the pneumatic bladder 502 from an external environment to increase pressure within the pneumatic bladder 502 and can further move the gas within the pneumatic bladder 502 and between the pressure regions 501a-f. The exhaust 518 can dispel air from the pneumatic bladder 502 to decrease pressure within the pneumatic bladder 502.

Alternatively, the fan 516 can be in fluid communication with the exhaust 518 to move exhausted gas into and within the pneumatic bladder 502. In other words, air can be recycled or recirculated within the pneumatic bladder 502. In this case, the (exhausted) gas within the pneumatic bladder 502 can have a greater temperature than an ambient temperature, and thus at least partially affect a stiffness of the facial interface 500 when the facial interface 500 includes a material (such as foam, elastic materials, silicone, etc.) with a stiffness that is temperature dependent.

In at least one example, the pneumatic tensioner 522 (stiffness profile modifier) can be actuated based on first sensor data generated by a first sensor 520a to cause to pneumatic bladder 502 to transition from having a first stiffness profile to having a second stiffness profile. As used herein, the term “actuate” refers to the initiation (or stopping) of a circulation cycle, a pumping cycle, an expansion cycle, etc. of a gas inside a pneumatic bladder. Additionally or alternatively, the term actuate includes the manipulation of a pneumatic bladder (e.g., in response to operation of a control valve or fan). The tensioner 522 can be configured to automatically change the facial interface 500 including the pneumatic bladder 502 from having a first stiffness profile to having a second stiffness profile. Additionally or alternatively, the tensioner 522 can be configured to automatically change the facial interface 500 from having either of the first stiffness profile or the second stiffness profile to having a third stiffness profile. As defined herein, the first stiffness profile can have a first configuration of stiffened areas and relaxed areas, the second stiffness profile can have a second configuration of stiffened areas and relaxed areas, and the third stiffness profile can have a third configuration of stiffened areas and relaxed areas. In at least one example, the tensioner 522 can actuate only some of the pressure regions based on sensor data or user input. For example, sensor data relating to the forehead area 203 can exceed a threshold criterion while sensor data relating to the zygoma region 205 and the maxilla region 203 can be below a threshold criterion, which can cause the tensioner to actuate only the forehead region 203 and not the zygoma region 205 or the maxilla region 203.

In a further example, the tensioner 522 can be configured to automatically change the facial interface 500 from having a second stiffness profile to having a third stiffness profile in response to additional sensor data. The third stiffness profile can have a third configuration of stiffened areas and relaxed areas. In at least one example, the tensioner 522 can be configured to automatically set the facial interface 500 to having a certain stiffness profile from a discrete set of predetermined stiffness profiles based on one or more sensor data. In this case, the discrete set of stiffness profiles can include the first stiffness profile, the second stiffness profile, the third stiffness profile, and/or a fourth, fifth, sixth, etc. In other examples, the tensioner 522 can be configured to automatically set the facial interface 500 to having a certain stiffness profile within a continuous range of stiffness profiles. The sensor data can include a timer, a thermometer, a camera, a tissue displacement sensor (e.g., skin or muscle movement sensor), an electrical sensor, and/or other appropriate sensor that can collect data relating to user facial comfort or condition.

In at least one example, the first sensor 520a can be configured to generate the sensor data and the additional sensor data. Additionally or alternatively, the head-mountable device can include a second sensor 520b configured to generate the additional sensor data (e.g., second sensor data). In at least one example, the tensioner 522 can be configured to actuate when the first sensor data and/or the second sensor data satisfy respective threshold criteria. A threshold criteria can refer to a quantifiable value (e.g., a preset value, a learned value, an adjustable value, etc.). In one example, a sensor can be a thermometer to measure a temperature of the user's face (or a zygoma region, a maxilla region, or a forehead region). The tensioner 522 can be actuated when the measured temperature exceeds a predetermined threshold temperature. In another example, a sensor can be a tissue displacement sensor. The tensioner 522 can be actuated when the tissue displacement exceeds a predetermined value (or decreases below a predetermined value) of tissue displacement.

In one example, the sensor 520a includes a timer. The pneumatic tensioner 522 can be actuated at predetermined time intervals. As used herein, the term “predetermined time intervals” refers to a scheduled time or a set amount of lapsed time. For example, the pneumatic tensioner 522 can actuate every five minutes, every fifteen minutes, every thirty minutes, etc. (e.g., according to user settings) during use of the head-mountable device. As another example, the sensor 520a includes a clock and the pneumatic tensioner 522 can actuate at scheduled times (e.g., according to user settings).

In one example, the pneumatic tensioner 522 can be configured to actuate in response to user interaction. For instance, the pneumatic tensioner 522 can actuate in response to user input with a manual control 524. As used herein, the manual control 524 can be any mechanism by which a user can interact with the tensioner 522. In at least one example, the manual control 524 is a button (e.g., a button positioned on the HMD 102, on a surface of at least one of the removable straps 110, 112, or on the electronics pod 116). In yet another example, the pneumatic tensioner 522 can actuate in response to user input at an external pump in fluid communication with the pneumatic bladder 502. In such a case, the external pump can include a manual pump, such as a hand pump, a foot pump, or other interactive pump. In other cases, the external pump can include automated pumps, such as battery-powered pumps.

In another example, head-mountable device can include the manual control 524 to actuate stiffness profile modifier. In other words, the pneumatic tensioner 522 can actuate in response to a user input via the manual control 524, which can include a dial, toggle switch, lever, button, slider, rocker switch, etc. to turn the fan 516 on or off to adjust the pressure within the pneumatic bladder 502 and/or the pressure regions 501a-f.

In one or more examples, the pneumatic tensioner 522 can actuate based on user activity. As used herein, the term “user activity” refers to physical acts performed by a user (sitting, standing, walking, jumping, exercising, etc.). User activity can also include device-based operations, such as playing a game, conducting a virtual meeting, watching a movie, performing work-based or productivity-based activities, etc. User activity can also include detection (e.g., by the sensor 520a) of a location or ambient environment of a user during operation or wearing of the device 100. For instance, a user activity can include being outdoors, being indoors, being in low-light conditions, being in bright-light conditions, etc. In an example use-case, the pneumatic tensioner 522 can actuate during or after gameplay (or application use), in-between games, during pauses, etc. (e.g., to improve user comfort). In another example, the facial interface 500 can have a first stiffness profile adjusted to prevent light from penetrating between the facial interface 500 and the face of the user during gameplay, and the facial interface 500 can have a second stiffness profile, that is overall less stiff than the first stiffness profile, during a pause or after gameplay to improve user comfort.

In one or more alternative examples (e.g., in addition to or alternatively to the pneumatic tensioner 522), the facial interface 300 can include at least one of a spring, an actuator, or a magnet. In certain implementations, the facial interface 300 includes these or other components for a facial massage, head massage, etc. Such components can promote increased comfort and relaxation over time and/or during extended-use sessions.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5. Addition details of an exemplary device including a thermal tensioner are detailed below with reference to FIG. 6.

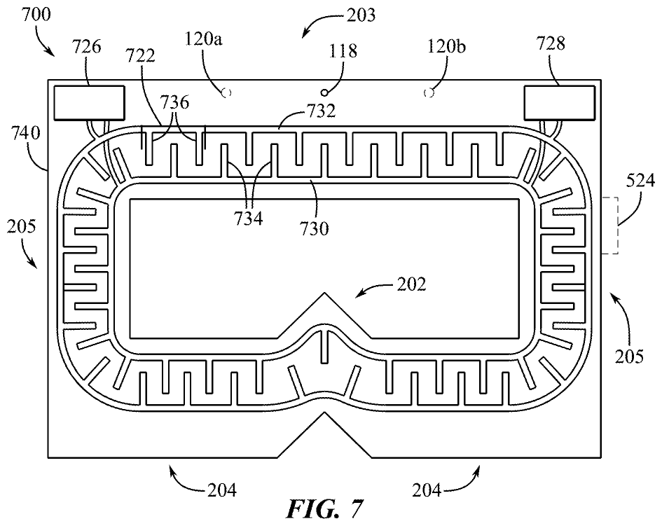

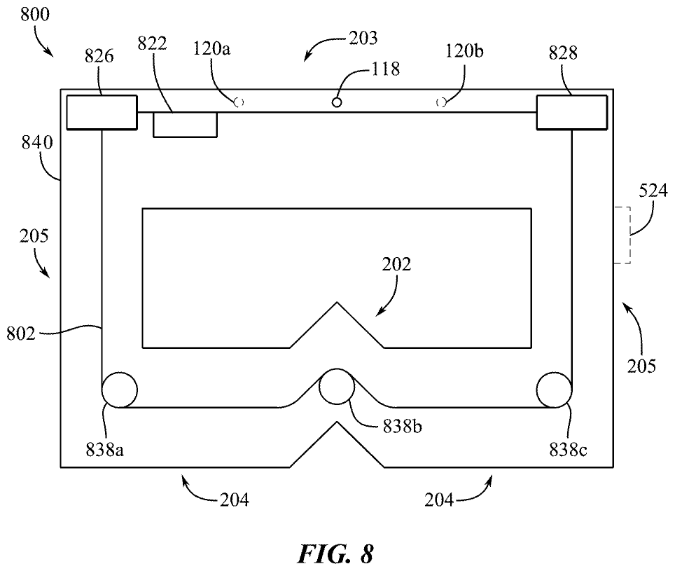

FIG. 6 illustrates a facial interface 600 of a head-mountable device with a thermal tensioner 622 including a first heater 626 and a second heater 628, according to one example. The facial interface 600 is substantially similar to the facial interface 500 of FIG. 5, 700 of FIG. 7, and 800 of FIG. 8, except that the facial interface 600 can include a different type of tensioner. The thermal tensioner 622 can also be referred to as a stiffness profile modifier. The facial interface 600 is similar to the facial interface 500 of FIG. 5, except for the stiffness profile modifier. The facial interface 600 can include a foam pad (e.g., a heat-reactive foam pad) that has a stiffness that is temperature dependent. In these or other examples, the foam pad can include open-cell foam, closed-foam, memory foam, charcoal foam, dry fast foam, high density foam, high resilience foam, latex foam, lux foam, polyurethane foam, polyethylene foam, re-bond foam, or a combination thereof. Additionally or alternatively, the facial interface 600 can include another heat-reactive material that has a stiffness that is temperature dependent.

The tensioner 622 can utilize induced-temperature flux to adjust a stiffness of various portions of the foam pad. In the depicted example, the tensioner 622 can generate the induced-temperature flux via the first heater 626 and the second heater 628. The first heater 626 can be configured to heat a first portion of the foam pad, and the second heater can be configured to heat a second portion of the foam pad that differs from the first portion of the foam pad. In particular, the thermal tensioner 622 can adjust a stiffness of the first portion and the second portion by adjusting a temperature of the respective portion of the facial interface 600.

As shown in FIG. 6, the facial interface 600 can include a first heat line 630 that can be coupled to the first heater 626. Additionally, the facial interface 600 can include a second heat line 632 that can be coupled to the second heater 628. Each of the heat lines 630 and 632 can be configured to transport heat from the source (the heaters 626 and 628, respectively) along the heat line. The heat lines 630 and 632 can run along the facial interface 600. The heat lines 630 and 632 can be disposed along different portions of the facial interface 600. In one example, the heat line 630 can be disposed about at least one of the zygoma region 205, the maxilla region 204, or the forehead region 203, while the heat line 632 can be similarly disposed about at least a different one of the zygoma region 205, the maxilla region 204, or the forehead region 203. Alternatively, in another example, the heat line 630 can be disposed about an inner perimeter of the facial interface 600, while the heat line 632 can be disposed about an outer perimeter of the facial interface 600.

In at least one example, the heat lines 630 and 632 can include a thermally conductive wire or heat transport line. For example the heat lines 630 and 632 can include diamond, silver, copper, gold, aluminum nitride, or the like that are thermally coupled to the heaters 526 and 528 which can conductively transfer thermal energy to the heat lines 630 and 632. The heat lines 630 and 632 can be disposed within the foam pad or adjacent the foam pad to transfer heat to the foam pad.

The heaters 626 and 628 can be any appropriate heater that can generate heat and transfer the heat to the heat lines 630 and 632. In one example, the first heater 626 and the second heater 628 can include a first infrared heater and a second infrared heater, respectively. In other example, the heaters 626 and 628 can include electric heaters, such as resistive heaters, that can be powered by a power source (e.g., battery, solar, etc.) of the heat-mountable device. In other example, the heaters 626 and 628 rely on intrinsic heat sources, such as heat from exhaust air, electrical component heat dissipation, heat dissipation from the user's head/face, etc. In some examples, the first heater 626 and the second heater 628 are not necessarily the same type of heater.

In at least one example, the first heater 626 and the second heater 628 are configured to operate at alternating times. In particular, the first heater 626 can be configured to operate for a first duration of time and the second heater 628 can be configured to operate for a second duration of time. For example, the first heat line 630 can be disposed along the zygoma region 204 of the user's face, and the second heat line 632 can be disposed along the forehead region 203 of the user's face. When the sensors 520a or 520b detect that the zygoma region 204 of the user's face has experienced prolonged contact, the first heater 626 can be operated to heat the heat line 630 for the first duration of time to soften the foam pad (facial interface 600) contacting the zygoma region 204. Furthermore, when the sensors 520a or 520b detect that the forehead region 203 of the user's face has experienced prolonged contact, the first heater 626 can be disabled and the second heater 628 can be operated to heat the heat line 632 for the second duration of time to soften the foam pad contacting the forehead region 203. In some examples, the first duration of time and the second duration of time can overlap. When the sensors 520a or 520b detect that both the zygoma region 204 and the forehead region 203 of the user's face has experienced prolonged contact, both heaters 526 and 528 can be operated.

The zygoma region 204 and the forehead region 203 are used as an illustrative example, but similar operations can apply to the maxilla region 205. Additionally or alternatively, the head-mountable device can include a third heater and a third heat line, such that there is one heater and one heat line corresponding to each of the zygoma region 204, the forehead region 203, and the maxilla region 205 of the user's face. Additionally or alternatively, the head-mountable device can include more than three heaters and more than three heat lines, such that one or more heaters and heat lines corresponds to each of the zygoma region 204, the forehead region 203, and the maxilla region 205 of the user's face.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6.

Whereas the above descriptions for FIGS. 5-6 discuss a pneumatic bladder and heat lines (e.g., solid heating or cooling wires), respectively, other implementations discussed below can include at least partially intermeshing tubes, bladders, heat lines, etc. FIG. 7 illustrates a facial interface 700 of a head-mountable device with a pneumatic heat tensioner 722, according to one example. The facial interface 700 is substantially similar to the facial interfaces 500 of FIG. 5, 600 of FIG. 6, and 800 of FIG. 8, except that the facial interface 700 can include a different type of tensioner (e.g., a different stiffness profile modifier). The pneumatic heat tensioner 722, is a type of stiffness profile modifier, that can automatically change the facial interface 700 from having a first stiffness profile to having a second stiffness profile in response to sensor data (e.g., from the sensors 118, 120a-b, and/or other sensors not illustrated in FIG. 7). The facial interface 700 can include a foam pad 740 or other heat-reactive material (e.g., a material that softens with increasing temperature and stiffens with decreasing temperature).

The head-mountable device can include a display portion having a display. The head-mountable device can also include a first heater 726 and a second heater 728. The first heater 726 can include a first pneumatic heat line 730 and can be configured to heat a first portion of the foam pad 740. The second heater 728 can include a second pneumatic heat line 732 and can be configured to heat a second portion of the foam pad 740. The tensioner 722 can utilize induced-temperature flux to adjust a stiffness of various portions of the foam pad 740. In the depicted example, the tensioner 722 can generate the induced-temperature flux along the first pneumatic heat line 730 and the second pneumatic heat line 732.

The first heater 726 and the second heater 728 can be heat-generating components which transfer heat to the first pneumatic heat line 730 and to the second pneumatic heat line 732, respectively. In at least one example, the first heater and 726 and the second heater 728 can include infrared heaters, which can emit infrared radiation to heat the first pneumatic heat line 730 and the second pneumatic heat line 732. In another example, the first heater 726 and the second heater 728 can utilize thermal exhaust from the head-mountable device to heat the first pneumatic heat line 730 and the second pneumatic heat line 732. As used herein, thermal exhaust refers to thermal output from the head-mountable device (for example, resulting from operation of electronic components). In this case, the first heater 726 and/or the second heater 728 can direct thermal exhaust into the first pneumatic heat line 730 and the second pneumatic heat line 732. In such examples, the first heater 726 and the second heater 728 induce a temperature flux within the first pneumatic heat line 730 and the second pneumatic heat line 732 to change the facial interface 700 from having the first stiffness profile to having the second stiffness profile.

The first pneumatic heat line 730 can run along/within a first portion of the facial interface 700, and the second pneumatic heat line 732 can run along/within a second portion of the facial interface 700. In at least one example, the first portion and the second portion of the facial interface 700 are different, such that the first heater 726 and the second heater 728 heat different portions of the facial interface. For example, as depicted in FIG. 7, the first pneumatic heat line 730 runs along an outer perimeter of the facial interface 700. The second pneumatic heat line 732 runs along an inner perimeter of the facial interface 700. In another example, the first pneumatic heat line 730 can run along at least one of the zygoma region 205, the maxilla region 204, the forehead region 203, or the nose region 202, and the second pneumatic heat line 732 can run along at least a different one of the zygoma region 205, the maxilla region 204, the forehead region 203, or the nose region 202.

In at least one example, the first pneumatic heat line 730 and the second pneumatic heat line 732 can include various features, such as branches 734 and 736, respectively. As shown in FIG. 7, the branches 734 and 736 can be alternately interlaced or intermeshed. Alternatively, the branches 734 and 736 can be interwoven, twisted, overlapped, etc. Such features can distribute heat from the first pneumatic heat line 730 and the second pneumatic heat line 732 more uniformly about the facial interface 700.

In at least one example, the first heater 726 and the second heater 728 can be configured to operate at alternating times. In particular, the first heater 726 can be configured to operate for a first duration of time while the second heater 728 is off. The second heater 728 can be configured to operate for a second duration of time while the first heater 726 is off. In another example, the first heater 726 and the second heater 728 can be configured to operate simultaneously for a first duration of time, to be simultaneously off for a second duration of time, and for a third and fourth duration of time, to be alternated in operation (one is off while the other is on).

As described above with respect to FIGS. 1-6, the head-mountable device can include a plurality of sensors to generate sensor data. The head-mountable device can include a controller communicatively coupled to the sensor(s), the first heater 726, and the second heater 728, and can operate the first heater 726 and the second heater 728 based on the sensor data. Sensors can be disposed at various locations of the head-mountable device, such as on/within the display portion, on/within the facial interface 700, along the securement strap, etc. For example, as depicted in FIG. 7, the head-mountable device can include the sensor 118 located within the display portion. The head-mountable device can include the sensors 120a and 120b located on the facial interface or the foam pad 740.

In at least one example, the sensor 118 can generate first sensor data. The sensor 120a can generate second sensor data. The first sensor data and/or the second sensor data can be representative of the user's facial comfort. In particular, the first sensor data and/or the second sensor data can be indicative of the user's facial muscle condition, facial coloring, facial sensory condition, etc. The tensioner 722 can be configured to actuate when the first sensor data and the second sensor data satisfy respective sensor data thresholds.

In one example, the sensor 118 can be a camera and the sensor 120a can be a timer. The tensioner 722 can actuate when a first threshold criterion is met, e.g., the camera detects that the user's face becomes sufficiently depressed or flushed (e.g., red or pink) where it contacts the facial interface 700. Additionally or alternatively, the tensioner 722 can actuate when a second threshold criterion is met, e.g., the timer has exceeded a duration of time that the facial interface has been in contact with the user's face. Additionally or alternatively, the tensioner 722 can actuate when both the first and the second criteria are met.

In a further example, the sensor 120b can be a thermometer. The tensioner 722 can actuate when a third threshold criterion is met, e.g., the user's facial temperature has exceeded a set temperature. The tensioner 722 can actuate when either the first criterion, the second criterion, or the third criterion are met; when the first criterion and the second criterion are met; when the second criterion and the third criterion are met; when the third criterion and the first criterion are met; or when the first criterion, the second criterion, and the third criterion are met. Similar methods for determining when the tensioner 722 is to be actuated can be applied for any applicable type of sensor and any number of sensors. In addition, the first sensor data, the second sensor data, and the third sensor data can correspond to measurements by different sensors, measurements by the same sensors at different times, or any combination.

In at least one example, the facial interface 700 can have a first stiffness profile. The first stiffness profile can be a default stiffness profile, a preset or predefined stiffness profile, etc., or a stiffness profile that is determined based on first sensor data. As described above, based on sensor measurements, the tensioner 722 can be actuated to change the facial interface 700 from having the first stiffness profile to having the second stiffness profile. Furthermore, the tensioner 722 can be configured to automatically change the facial interface from having the second stiffness profile to having a third stiffness profile in response to additional sensor data (e.g., data for additional sensors, data taken at a later time, or a combination).

Whereas the above description for FIGS. 5-7 respectively discusses a pneumatic bladder, heat lines (e.g., solid heating or cooling wires), and pneumatic heating, other implementations discussed below can include at least partially intermeshing tubes, bladders, heat lines, etc. FIG. 8 illustrates a facial interface 800 of a head-mountable device with a mechanical tensioner 822, according to one example. The facial interface 800 is substantially similar to the facial interfaces 500-700 of FIGS. 5-7, except that the facial interface 800 can include a different type of tensioner (e.g., a different stiffness profile modifier). The facial interface 800 can include a foam pad 840 that is stretchable and/or compressible.

In particular, the mechanical tensioner 822 can include (or communicate with) a pulley system 826 having a line 802 and one or more pulleys (e.g., pulleys 838a-838c). The line 802 can be a string, a cord, a cable, or another length of fiber that runs along/within at least a portion of the facial interface 800 and engages with the pulley 838a. The pulley 838a can be a wheel or bearing with a track about which the line 802 can run. The pulley 838a can be disposed at a position along the facial interface 800, such as at a corner or a bend portion of the facial interface 800, such that the foam pad 840 is tightened by the line 802 when the pulley system 826 is actuated. The pulley system 826 can include mechanisms for tightening/loosening the line 802. For example, the pulley system 826 can include a motor, a spool, ratcheting components, etc.

In these or other examples, the pulley system 826 can actuate certain pulleys to lift certain portions of the facial interface 800 away from the user's face. Additionally or alternatively, the pulley system 826 can actuate other pulleys to release, let down, or push portions of the facial interface 800 against a user's face. In certain implementations, the actuatable portions are interspaced by unraised portions (e.g., the line 802 can raise portions away from the user's face, where these raised portions are interspaced by un-raised or lowered portions that remain in contact with a user's face). Similarly, another line can be tensioned via pulleys to raise the previously unraised or lowered portions while the line 802 is de-tensioned to let down the previously raised portions. Thus, two or more tension-able lines (like the line 802) can be actuated by the mechanical tensioner 822 to provide a dynamic response to detected sensor data, as described above.

As depicted in FIG. 8, the pulley 838a is disposed at a corner of the facial interface 800 between a zygoma region 205 and a maxilla region 204. In some examples, the pulley system 826 includes additional pulleys, such as pulley 838b and pulley 838c that can be disposed at different positions along the facial interface 800. As depicted in FIG. 8, the pulley 838c is disposed at a (different) corner of the facial interface 800 between a (second) zygoma region 205 and the maxilla region 204. As depicted in FIG. 8, the pulley 838b is disposed at a nose region 202 of the facial interface 800. In at least one example, this particular configuration of pulleys 838a-c can allow for modifiable pressure regions along the zygoma regions 205, the maxilla regions 204, and the nose region 202 to be changed from having a first stiffness profile to having a second stiffness profile.

Although not explicitly shown, the pulley system 826 can include any number of pulleys disposed at different positions along the facial interface 800. For example, the pulley system can include a component which includes a pulley disposed at a corner between the forehead region and the (second) zygoma region 205. In at least one example, this particular configuration of pulleys can allow for modifiable pressure regions along the (second) zygoma region 205 and the forehead region 203 to be changed or adjusted when the pulley system 826 is actuated.

Alternatively, although not explicitly shown, the component can include a pulley system. In this particular example, the pulley system 826 and the pulley system 828 can be independently actuated or simultaneously and symmetrically actuated to modify pressure regions along each of the zygoma regions 205, the maxilla regions 204, the forehead region 203, and/or the nose region 202. Actuation of the pulley system 826 and or they pulley system 828 can be based on sensor data from the sensors 118, 120a, 120b, etc.

In some examples, the head-mountable device can also include more than one line, such as line 802. For example, the head-mountable device can include a first line 802 disposed between the pulley system 826, the pulley 838a, and the pulley 838b; and a second line disposed between the pulley system 828, the pulley 838c, and the pulley 838b. Such configuration can allow for pressure regions corresponding to the left and right sides of the facial interface to be independently modified. In other examples, any number of lines, pulleys, and/or pulley systems can be implemented, in particular to customize adjustability of various pressure regions around the perimeter of the facial interface 800.

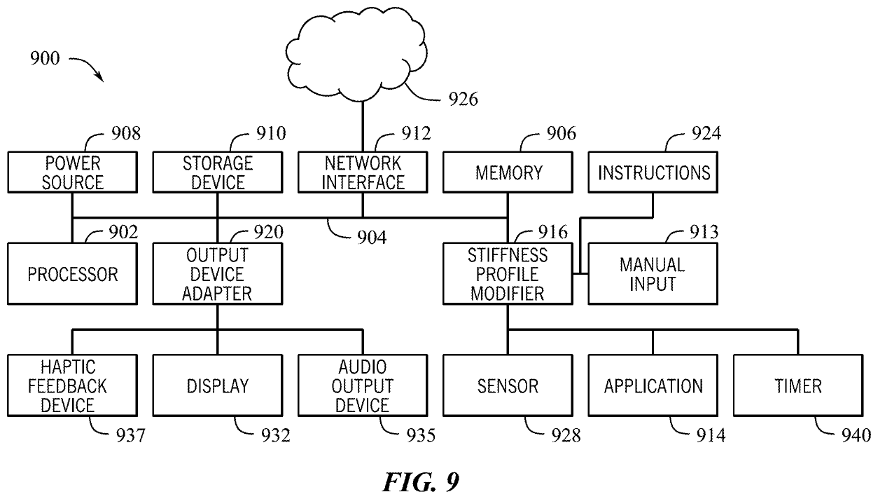

Any of the features, components, and/or parts, including the arrangements and configurations thereof shown in FIG. 8 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8. Additional details of an exemplary device including any or all of the features of the electronic devices described herein with respect to FIGS. 1-8 are provided below with reference to FIG. 9.

FIG. 9 shows a high-level block diagram of an electronic device 900 that can be used to implement examples of the present disclosure. In various embodiments, the electronic device 900 can include various sets and subsets of the components shown in FIG. 9. Thus, FIG. 9 shows a variety of components that can be included in various combinations and subsets based on the operations and functions performed by the electronic device 900 in different examples. It is noted that, when described or recited herein, the use of the articles such as “a” or “an” is not considered to be limiting to only one, but instead is intended to mean one or more unless otherwise specifically noted herein.

The electronic device 900 can include a central processing unit (CPU) or processor 902 connected via a bus 904 for electrical communication to a memory device 906, a power source 908, an electronic storage device 910, a network interface 912, an input device adapter 916, and an output device adapter 920. The processor 902 can additionally be communicatively coupled to a stiffness profile modifier 916 (e.g., tensioner). For example, one or more of these components can be connected to each other via a substrate (e.g., a printed circuit board or other substrate) supporting the bus 904, and other electrical connectors providing electrical communication between the components. The bus 904 can include a communication mechanism for communicating information between parts of the electronic device 900.

The processor 902 can be a microprocessor or similar device configured to receive and execute a set of instructions 924 stored by the memory device 906. The memory device 906 can be referred to as main memory, such as random access memory (RAM) or another dynamic electronic storage device for storing information and instructions to be executed by the processor 902. The memory device 906 can also be used for storing temporary variables or other intermediate information during execution of instructions executed by the processor 902. The power source 908 can include a power supply capable of providing power to the processor 902 and other components connected to the bus 904, such as a connection to an electrical utility grid or a battery system.

The storage device 910 can include read-only memory (ROM) or another type of static storage device coupled to the bus 904 for storing static or long-term (i.e., non-dynamic) information and instructions for the processor 902. For example, the storage device 910 can include a magnetic or optical disk (e.g., hard disk drive (HDD)), solid state memory (e.g., a solid state disk (SSD)), or a comparable device.

The instructions 924 can include information for executing processes and methods using components of the electronic device 900. Such processes and methods can include, for example, the methods described in connection with other embodiments elsewhere herein, including, for example, the methods and processes described in connection with FIG. 9.

The network interface 912 can include an adapter for connecting the electronic device 900 to an external device via a wired or wireless connection. For example, the network interface 912 can provide a connection to a computer network 926 such as a cellular network, the Internet, a local area network (LAN), a separate device capable of wireless communication with the network interface 912, other external devices or network locations, and combinations thereof. In one example embodiment, the network interface 912 is a wireless networking adapter configured to connect via WI-FI®, BLUETOOTH®, BLE, Bluetooth mesh, or a related wireless communications protocol to another device having interface capability using the same protocol. In some embodiments, a network device or set of network devices in the network 926 can be considered part of the electronic device 900. In some cases, a network device can be considered connected to, but not a part of, the electronic device 900.

The stiffness profile modifier 916 can be configured to receive input from various input devices such as, for example, a manual input 913 (e.g., from a manual control 524), a keyboard or other peripheral input device, one or more sensors 928 (e.g., 118 and 120), applications 914, timers 940, etc., related devices, and combinations thereof. In an example embodiment, the stiffness profile modifier 916 is connected to the input sources described herein to determine a stiffness profile of the electronic device 900.

The output device adapter 920 can be configured to provide the electronic device 900 with the ability to output information to a user, such as by providing visual output using one or more displays 932, by providing audible output using one or more speakers 935, by providing haptic feedback sensed by touch via one or more haptic feedback devices 937, or by actuating the stiffness profile modifier 916. Other output devices can also be used. The processor 902 can be configured to control the output device adapter 920 to provide information to a user via the output devices connected to the adapter 920.

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A head-mountable device, comprising:
a display portion including a display;
a facial interface connected to the display portion, the facial interface including a variable stiffness profile;
a sensor configured to generate sensor data; and
a stiffness profile modifier connected to the sensor, the stiffness profile modifier configured to change the facial interface from a first stiffness profile to a second stiffness profile in response to the sensor data.

2. The head-mountable device of claim 1, further comprising a securement assembly connectable to the display portion, the securement assembly comprising:
a removable strap comprising electronics; and
a retention band connectable to the removable strap;
wherein:
the facial interface comprises a heat reactive foam;
the stiffness profile modifier comprises a heater;
the first stiffness profile comprises a first configuration of a first stiffened area and a first relaxed area; and
the second stiffness profile comprises a second configuration of a second stiffened area different than the first stiffened area and second relaxed area different than the first relaxed area.

3. The head-mountable device of claim 1, wherein the first stiffness profile is based on a user activity.

4. The head-mountable device of claim 1, wherein the stiffness profile modifier induces a temperature flux to change the facial interface from the first stiffness profile to the second stiffness profile.

5. The head-mountable device of claim 1, wherein the stiffness profile modifier comprises a pump.

6. The head-mountable device of claim 1, wherein the stiffness profile modifier is further configured to change the facial interface from the second stiffness profile to a third stiffness profile in response to additional sensor data.

7. The head-mountable device of claim 1, further comprising a manual control to actuate the stiffness profile modifier.

8. The head-mountable device of claim 1, wherein the sensor comprises a timer.

9. The head-mountable device of claim 1, wherein the sensor is positioned on or within the facial interface.

10. An apparatus, comprising:
a display portion including a display;
a face-engaging structure with a first modifiable pressure region and a second modifiable pressure region;
a tensioner comprising at least one of a mechanical tensioner or a pneumatic tensioner connected to the first modifiable pressure region and the second modifiable pressure region;
a first sensor configured to generate a first sensor data; and
a second sensor configured to generate a second sensor data;
wherein the tensioner is configured to actuate when the first sensor data satisfies a first threshold criteria and the second sensor data satisfies a second threshold criteria.

11. The apparatus of claim 10, wherein the tensioner comprises at least one of a spring, an actuator, or a magnet.

12. The apparatus of claim 10, wherein the tensioner comprises at least one of a pulley or a bladder.

13. The apparatus of claim 10, wherein the first sensor comprises a camera, and the second sensor comprises at least one of a tissue displacement sensor or an electrical signal sensor.

14. The apparatus of claim 10, wherein:
the first modifiable pressure region corresponds to at least one of a zygoma region, a maxilla region, or a forehead region on a human head; and
the second modifiable pressure region corresponds to at least one of a zygoma region, a maxilla region, or a forehead region on a human head different than the first modifiable pressure region.

15. A wearable apparatus, comprising:
a display portion including a display;
a foam pad connected to the display portion;
a first heater configured to heat a first portion of the foam pad;
a second heater configured to heat a second portion of the foam pad different from the first portion of the foam pad;
a sensor; and
a controller communicatively coupled to the sensor, the first heater, and the second heater.

16. The wearable apparatus of claim 15, wherein the foam pad comprises a heat-reactive foam.

17. The wearable apparatus of claim 15, wherein the first heater and the second heater are configured to operate at alternating times.

18. The wearable apparatus of claim 15, wherein:
the first heater comprises a first infrared heater; and
the second heater comprise a second infrared heater.

19. The wearable apparatus of claim 15, wherein:
the first heater comprises a first pneumatic heat line; and
the second heater comprises a second pneumatic heat line.

20. The wearable apparatus of claim 15, wherein the first heater and the second heater are configured to use a thermal exhaust from the wearable apparatus.
